(19) United States
(12) Patent Application Publication
(10) Pub. No.: US 2009/0059175 A1
(43) Pub. Date: Mar. 5, 2009

(54) DISPLAY ARRANGEMENT

(75) Inventors: Robert Le Quesne, Milan (IT); Richard Lockard, Milan (IT)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: The Big Space Ltd., Milan (IT)

(21) Appl. No.: 11/847,570

(22) Filed: Aug. 30, 2007

(51) Int. Cl. G03B 21/26

(52) U.S. Cl. 353/28

(57) ABSTRACT

A display arrangement having a user-facing side, the display arrangement comprising a display device and a data reader device for reading data from a data carrier associated with an item, including item identification data. The display arrangement has a database interface for accessing a database, which stores content data in correspondence with item identification data. The display device is responsive to item identification data being read by the data reader device from a data carrier to display content data on the user-facing side. The user-facing side includes a mirror, and a user sees both a reflection from the mirror and the displayed image when the user is in front of the user-facing side.

### FIELD OF THE INVENTION

The present invention relates to a display arrangement, in particular but not exclusively for retail stores, showrooms and the like.

### BACKGROUND OF THE INVENTION

Display arrangements which are capable of displaying marketing content and/or product information in a retail store are known. These displays can take various forms, including shelf-mounted signs which are switched on when a sensor detects a person nearby.

Japanese patent application JP2006-03044 describes a Point-of-Purchase (POP) display which is capable of reading a Radio Frequency Identification (RFID) tag attached to a product and, on the basis of that reading, to display content about that product.

It is an object of the invention to provide improved display arrangements, in particular but not exclusively for retail stores, showrooms and the like.

### SUMMARY OF THE INVENTION

In accordance with the present invention, there is provided a display arrangement having a user-facing side which, in use, faces a user, the display arrangement comprising:

a display device; and

a data reader device for reading data from a data carrier associated with an item, said data including item identification data,

wherein said display arrangement has a database interface for accessing a database, said database storing content data in correspondence with item identification data for a plurality of items,

said display device being responsive to item identification data being read by said data reader device from a data carrier to display content data on said user-facing side,

wherein said user-facing side includes a mirror, and

wherein a user sees both a reflection from said mirror and said displayed image when the user is in front of said user-facing side.

The present invention provides for a display arrangement that allows a person to view not only their reflection in the mirror but also to view a display of information relating to an item which is brought up to the mirror.

Preferably, the mirror is partly-transmissive, the mirror having a rear side and said display device being arranged to display an image towards said rear side, the image being visible through said partly-transmissive mirror.

In one embodiment, the display arrangement is RFID-enabled and is capable of displaying an image in response to the data reader device of the display arrangement detecting an RFID tag.

In a preferred embodiment, RFID tags are attached to clothing items and the display arrangement is capable of providing item information and/or related item information in response to a person holding, wearing or otherwise placing in a required proximity relationship a clothing item in front of the mirror. Related item information may include information relating to one or more complementary recommended items.

In preferred embodiments, the mirror is touch-sensitive so that a person may interact with the content displayed in the display area.

The display arrangement of the invention, when used in a retail environment, provides for an improved customer service by assisting a customer in a purchasing decision and provides retailers with the possibility to increase sales.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1A shows a schematic side view of the display arrangement in accordance with an embodiment of the present invention;

FIG. 1B shows a front view of the display arrangement along lines A-A of FIG. 1A;

FIG. 2 is a block diagram of the display arrangement illustrating the components of the arrangement and the operation of the arrangement in accordance with an embodiment of the present invention;

FIG. 3A shows the display arrangement in an idle state in accordance with an embodiment of the present invention;

FIG. 3B shows the display arrangement in an active state in accordance with an embodiment of the present invention;

FIG. 4A is a schematic view of a display arrangement in accordance with an embodiment of the present invention;

FIG. 4B shows the display arrangement of FIG. 4A in an active state in accordance with an embodiment of the present invention;

FIGS. 5 to 9 are flow diagrams illustrating the operation of different applications of the software in accordance with an embodiment of the present invention;

FIG. 10 is a flow diagram illustrating the operation of a handheld device in combination with the display arrangement in accordance with an embodiment of the present invention.

### DETAILED DESCRIPTION OF THE INVENTION

An embodiment of the display arrangement of the present invention will now be described. Note that, whilst this embodiment as described includes RFID tags attached to, or embedded in, individual items, the display arrangement may include any type of radio frequency (RF) tags or magnetic tags, such as Universal Product Code (UPC) bar coded labels attached to individual items.

For the purposes of this application, the term “tag” is used but terms such as “label”, “transponder”, “chip”, etc. should be understood as alternatives or equivalents.

In a preferred embodiment, the items are in a retail store, such as a clothing store. Some or all items sold at the store, e.g. shirts, trousers, coats, shoes, may include an RFID tag which stores information about the item, such as the name of the manufacturer, the item price, the name of the item, identification data such as a unique identification number, etc. The display arrangement of the present invention is configured to automatically detect items when they are brought in front of the mirror. The display arrangement may, in addition or alternatively, interact with any radio frequency (RF) tags or magnetic tags, such as Universal Product Code (UPC) bar coded labels attached to individual items. The display arrangement is preferably mains electricity or battery powered but may be powered by any other means.

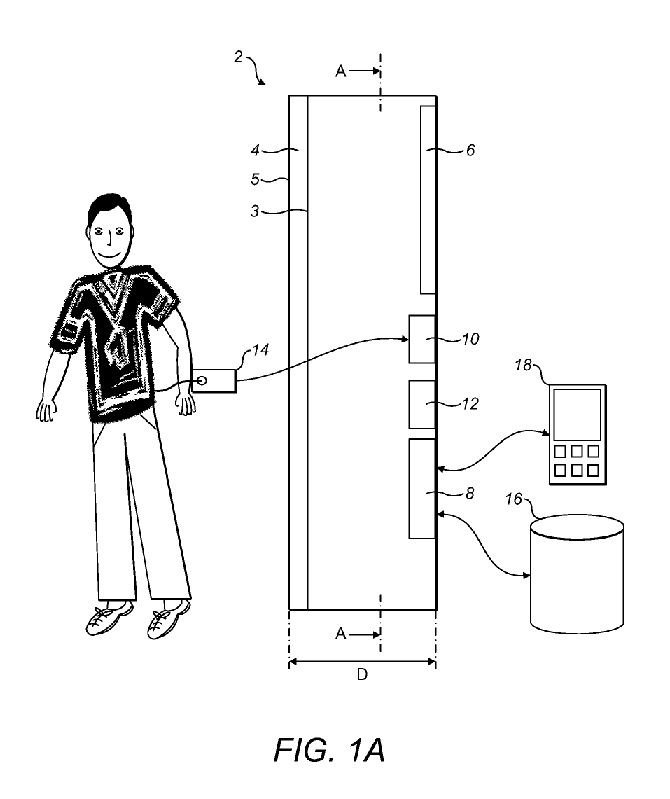

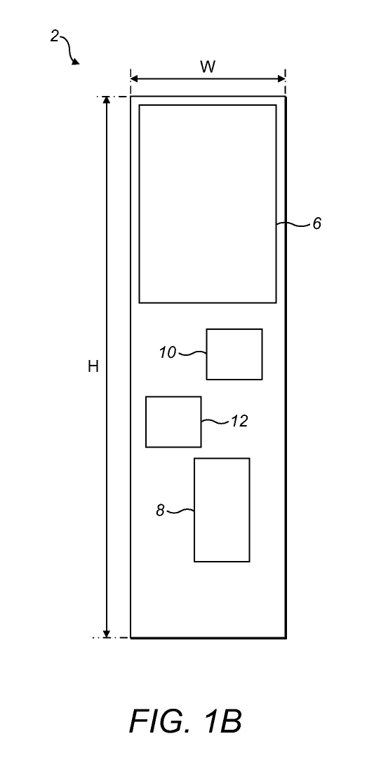

Referring now to FIGS. 1A and 1B, a display arrangement 2 in accordance with an embodiment of the present invention is schematically illustrated. The display arrangement 2 is an enclosure which includes a user-facing side, and having a mirror 4 on the user-facing side. Note that the user-facing side preferably includes a single glass panel, but may be made up of a plurality of separate panels.

A display device 6, processing means such as a computer terminal 8 having software stored thereon, an RFID reader antenna 10 and an associated RFID reader 12 are provided in the inside of the enclosure and are preferably not visible from the outside of the enclosure. The antenna 10 is capable, in a known manner, of interacting with an RFID tag 14 disposed on or embedded in an individual item 16, which is in this embodiment a clothing item. The RFID reader 12 which is connected to the antenna 10 extracts identification data from other data received in a signal from an RFID tag 14.

The user-facing side includes a mirror area and a display area, which may be separate or which may overlap, in whole or in part. In this embodiment, the display area is smaller than the mirror area and is entirely within the mirror area. The mirror in at least the display area includes a rear surface side 3 and a front surface side 5. Where the mirror area and the display area overlap, as in this embodiment, they may be embodied in at least the overlap area as a partly transmissive mirror. A reflective coating is applied on the rear surface side 3 or the front surface side 5 of a glass panel, the coating comprising for instance metallic particles, so that the glass surface is partly-transmissive throughout. The glass surface of the mirror is in this embodiment part-reflective and part-transmissive, this type of mirror being commonly known as a half-silvered mirror or a semi-transparent mirror.

The display arrangement 2 is designed to be placed in a retail store, in particular in a fitting room of a clothing store, and may be wall-mounted or mounted within a frame which is designed for free-standing on a flooring surface. Alternatively, the display arrangement may be a counter-top display arrangement. The mirror 4 has in this embodiment unequal width and height, with width, height and depth being indicated by the arrows W, H and D, respectively, in FIGS. 1A and 1B. The mirror 4 is in this embodiment a so-called “full-length” mirror capable of showing a reflection of a typical human along substantially their entire height, and preferably has a height of at least 150 cm, preferably more than 180 cm and a width of at least 40 cm, preferably more than 50 cm. In this embodiment, the mirror has a width of 60 cm and a height of 190 cm.

Note that in certain embodiments of the invention, more than one display arrangements as shown in FIGS. 1A and 1B may be provided side-by-side. A single mirror panel is preferably provided in such case, which is shared by each of a plurality of display devices.

The display device 6 of the display arrangement is in this embodiment a light-emitting display device, for example a 32-inch liquid crystal display (LCD). Alternatively, two or more smaller display devices, such as 15-inch LCD displays, may be juxtaposed to form a combined display. Other types of display devices may be used, for example a field-emission display, an electron-ray indicator tube, an electroluminescence display, a liquid-crystal display having a backlight or the like. The display device 6 is oriented so that the light emitted by the display device is directed towards the rear surface side 3 of the mirror 4. The mirror 4 being partly-transmissive in at least the display area, the light emitted by the display device is transmitted through the mirror (i.e. from the rear surface to the front surface) allowing the image displayed on the display device to be seen on the front side surface 5 of the mirror in juxtaposition with a reflection of a person standing in front of the mirror 4.

The computer terminal 8 includes a central processing unit (CPU), memory, a data storage device such as a hard disc drive and I/O devices which facilitate interconnection of the computer terminal 8 with the mirror display device 6, the RFID reader antenna 10, the RFID reader 12, a database 16, at least one handheld device 18 and the touch-sensitive mirror surface. Operating system programs are stored on the hard disc drive, and control, in a known manner, low level operation of the computer terminal. Different software applications which will be described below are also stored on the hard disc drive. These software applications control outputs to the mirror display device 6 and inputs from the touch-sensitive mirror surface. The hard disc drive may comprise a database 16, which will be referred to as an item database 16, for storing content data, in particular item information and, preferably, related item information. Note that the database may also be held on other types of data storage media, such as optical storage media.

The item information is associated in the item database 16 with item identification data. The item information may be an in-depth description of a clothing item including its price, size, color, material, availability and/or location in the store. The related information includes for example information indicating the availability of a similar clothing item in a particular size and/or color, suggestions for mixing clothing items, one or more suggested accessories and multimedia content such as advertising/promotional media content, collection media content and brand media content.

The item database 16 may be stored locally, in the retail store. Alternatively, the item database 16 may be located remotely and accessible by the computer terminal 8 via a wireline link or a wireless link (e.g. Bluetooth™).

A customer database may also be stored on the hard drive of the computer or, alternatively, may be accessed remotely by the computer. In the case that the item database 16 and/or the customer database are stored on the hard disc drive, each respective database may be updated remotely.

The display arrangement 2 may also comprise one or more audio speakers (not shown) so that information displayed on the display device 6 may be accompanied by audio content, the playback of which is based on data also retrieved from, or at least triggered by information retrieved from, the item database 16.

In a preferred embodiment, the mirror 4 is a touch-sensitive mirror so that a person may be able to interact with the mirror front surface 5 and access further, more detailed, information regarding one or more clothing items of interest, which further information may also be retrieved from the item database 16.

An act by a user of touching the front surface of the mirror 4, e.g. when a user touches the front surface of the mirror with a finger, may be sensed using a known touch sensitive system such as the ReverSys™ system developed by the company Sensitive Object. In this embodiment, the display arrangement determines the location of a point of impact on the front surface of the mirror using at least two acoustic sensors (not shown), such as microphones or piezoelectric transducers which are for instance located on the rear surface of the mirror 4, to sense signals which are processed using touch signal processing software which may be stored on the hard disc drive of the computer terminal 8. An acoustic signal generated by an impact is sensed by the acoustic sensors and transmitted to the computer terminal 8 for conversion into an audio file which is compared to pre-existing audio profiles (also called acoustic signatures) corresponding to different positions on the mirror surface. A specific gesture is also associated an acoustic signature so that, for example a stroke at a specific location on the front surface 5 of the mirror 4 may be recognised and trigger a particular response, typically involving further information being displayed on the display device 6.

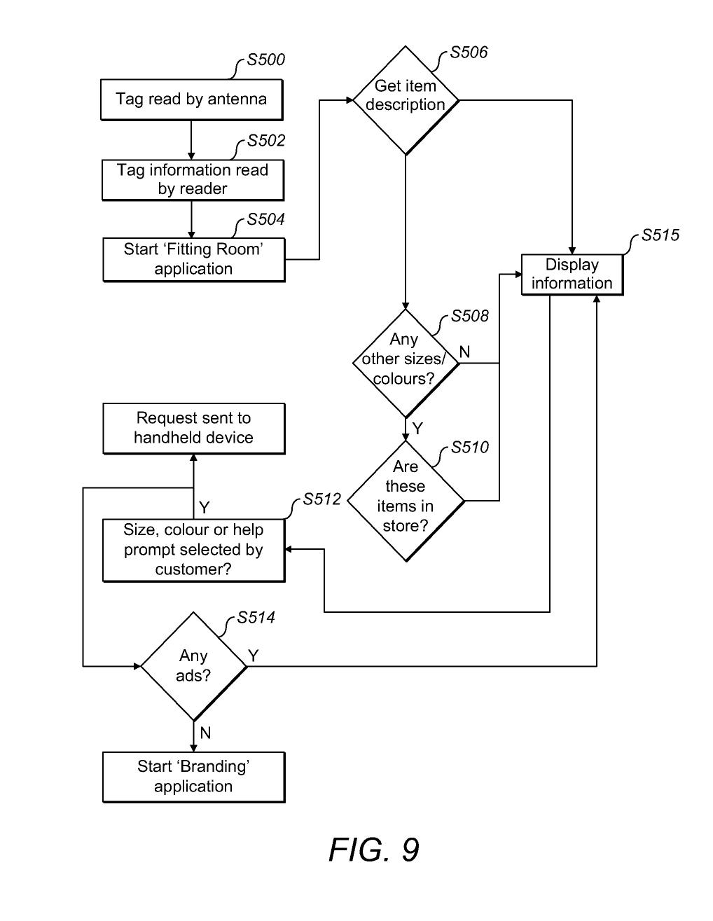

Also, the display arrangement 2 of the present invention preferably communicates wirelessly, via Bluetooth™ for instance, with at least one handheld device 18, such as a personal digital assistant (PDA), which may for example be carried by a salesperson in the clothing store. Details about the clothing item in possession of the customer may be transmitted to and displayed on the PDA. Additionally, or alternatively, a button (not shown) may be located on one side of the enclosure of the display arrangement 2 and used, when activated by a customer, to wirelessly request help from a salesperson. Details of the operation of a handheld device 18 in combination with the display arrangement 2 of the present invention will be provided in relation to FIG. 9.

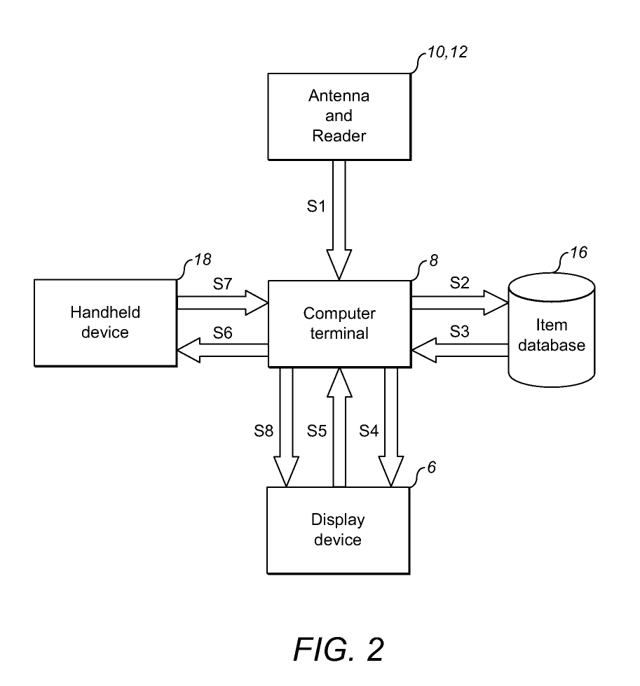

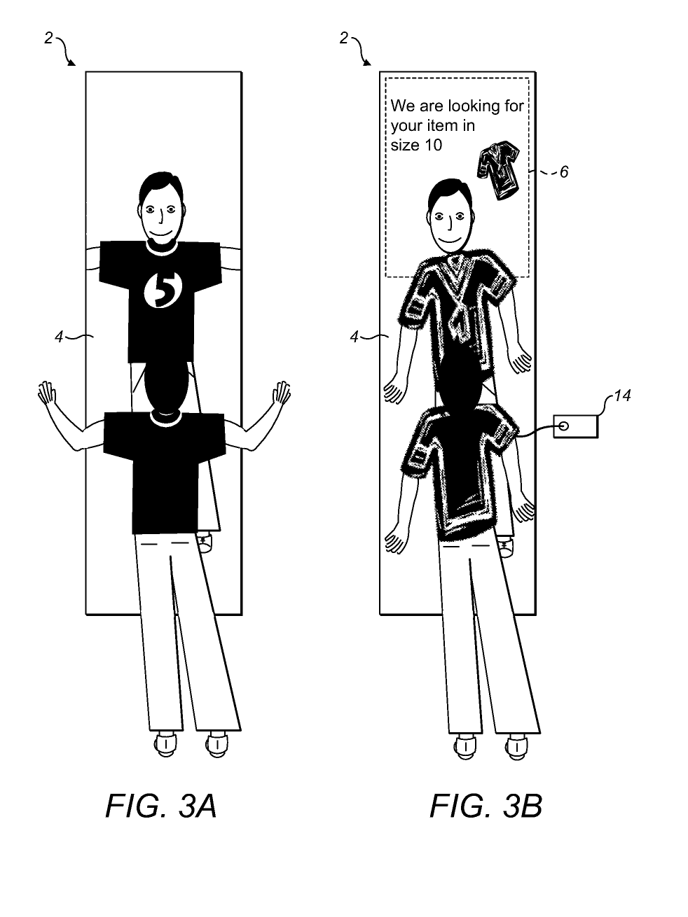

Turning now to FIG. 2, the operation of the display arrangement 2 in accordance with an embodiment of the present invention is as follows. The mirror 4 is initially in an ‘idle’ state and a person can see his/her reflection in the partly-transmissive mirror 4 as shown in FIG. 3A. When a customer in possession of a clothing item 16 carrying an RFID tag 14 approaches the display arrangement 2, the RFID reader 12 extracts and separates the item identification data from other data comprised in a signal from the tag 14 received at the RFID reader antenna 10.

In step S1, the item identification data is transmitted from the RFID reader 12 to the computer terminal 8 which queries the item database 16 (step S2) in order to obtain information about the item and/or related information, in step S3. The item information and/or related information is displayed to the customer on the display device 6, step S4, the partly-transmissive mirror switching to an ‘active’ mode in which the mirror's reflection of the customer is combined with item information and/or related information (as shown in FIG. 3B). As mentioned above, this juxtaposition is possible because the mirror 4 is a partly-transmissive mirror. Presuming the mirror 4 is touch-sensitive, when a user input is detected on the interactive mirror front surface, step S5, such input is processed by the computer terminal 8 and a message is transmitted to at least one remote handheld device 18, step S6. A user input may for instance corresponds to a user tapping on a “bigger size” prompt or a “smaller size” prompt displayed on the display 6 and thus visible on the mirror front surface. A customer may thus be able to contact a salesperson carrying a handheld device 18 to obtain the clothing item he is trying in a different size without the trouble of getting dressed to go and get it himself on the shelves. One advantage of this that customers are more likely to buy an item that fits, reducing item returns. A response may be inputted in the handheld device by the salesperson and transmitted to the computer terminal 8, step S7, which forwards the response to the display device 6 in order to be displayed to the customer, step S8. In the case that an RFID tag has no associated content in the item database 16, a corresponding message and/or promotional content may be displayed to the customer.

In one embodiment, the display arrangement 2 comprises a motion sensor (not shown) which is typically located above or below the mirror front surface 5. Whether or not a customer approaching the display arrangement 2 holds or wears a tagged clothing item, the display device is activated in response to the sensor detecting the person's presence. The display device may, in response to the sensing of a person's presence, display advertising material, user prompts and/or any other information content.

In another embodiment, a camera (not shown) may be fitted to the display arrangement 2 so that an image of a customer captured by the camera may also be displayed on the display device 6. The customer image may be combined with one or more images of one or more clothing items for instance.

Also, when a customer tries on a clothing item, an entire outfit may be displayed on the display with the possibility for the customer to select at least parts of the outfit to place an order with a salesperson via the handheld device 18.

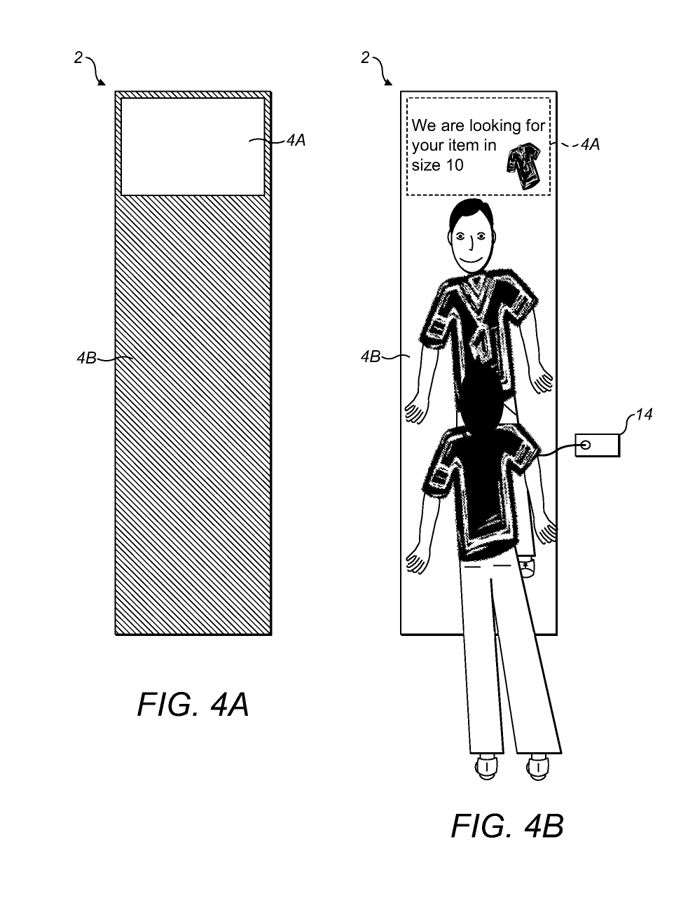

In the alternative embodiment shown schematically in FIG. 4A, the display arrangement 2 might include a first part 4A which is relatively, or entirely, transmissive and a second part 4B which is less transmissive or entirely reflective. The display device 6 is mounted in correspondence with the first part 4A, which is preferably located at the top of the display arrangement.

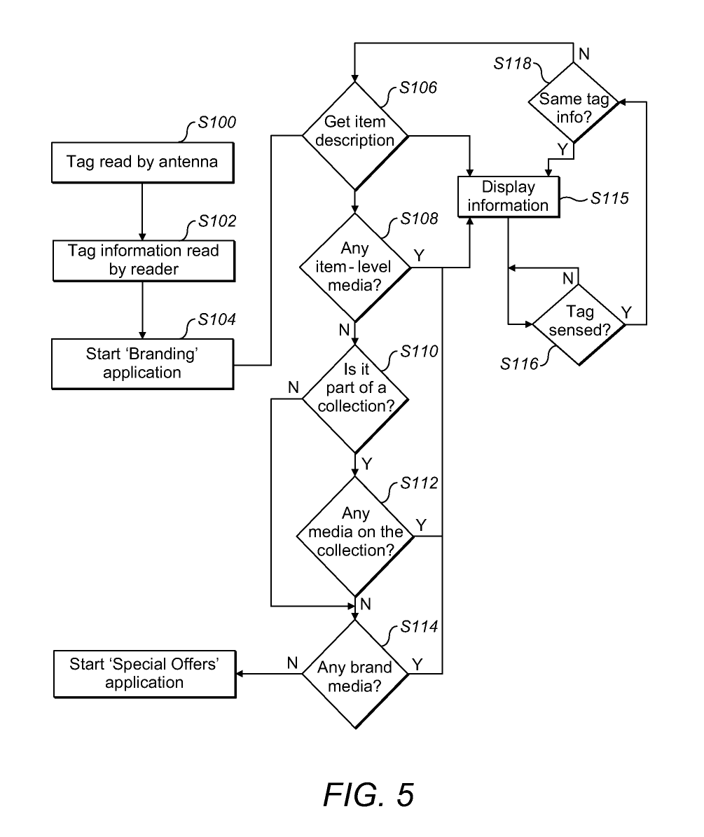

FIGS. 5 to 9 are flow diagrams illustrating different software applications in accordance with an embodiment of the present invention. A retailer may choose one or more of these software applications to be installed on the hard disc drive of the computer terminal 8.

### ‘Branding’ Software Application

FIG. 5 illustrates the operation of the ‘branding’ software application which shows relevant information to a clothing item and/or to a clothing brand when such an item is held in front of the display arrangement 2 of the present invention. The operation of the ‘branding’ software application is as follows.

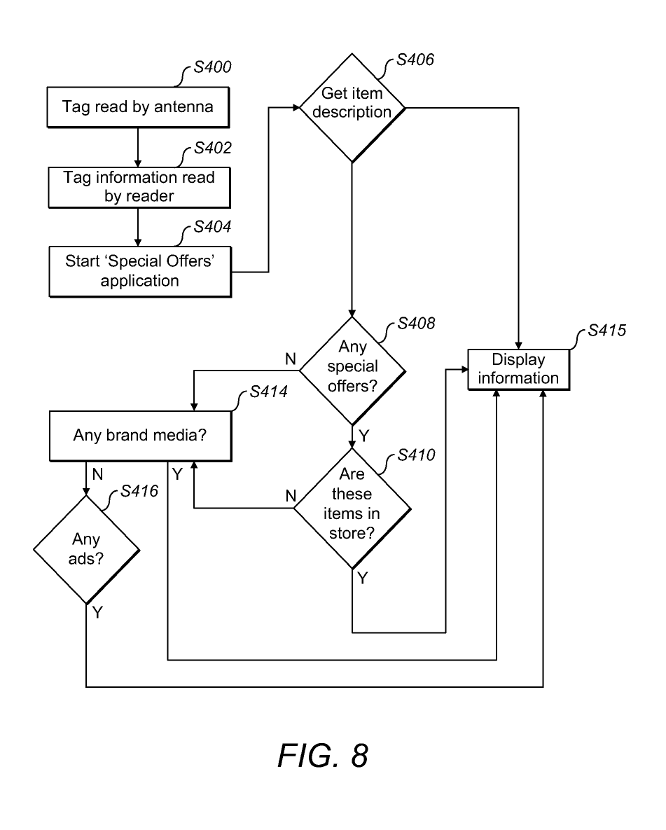

Presuming a person who approaches the display arrangement 2 is holding or wearing a clothing item 16, the RFID tag 14 attached to the clothing item 16 is read by the RFID reader antenna 10 in step S100 and the information (including item identification data) stored on the RFID tag 14 is decoded and read by the RFID reader 12, step S102. In step S104, the ‘branding’ software application is launched triggering information about the clothing item 16 (e.g. price, size, color, material, etc.) to be retrieved from the RFID tag 14 or from the item database 16, step S106, and displayed on the display device 6, step S115. It is then determined whether there is any media content relating to the clothing item in the item database 16, step S108. If yes, such media content is displayed, in step S115. If no, it is determined whether the clothing item 16 is part of a collection, step S110. If yes, it is then determined if there is any media content relating to the collection in the item database 16, step S112. If yes, such media content is displayed, in step S115. If the clothing item 16 is not part of a collection or if there is no media content available for the collection the clothing item 16 is part of, it is determined in step S114 whether there is any brand media content in the item database 16. If yes, the brand media content is displayed, in step S115. If not, the ‘special offers’ software application, which will be described in relation to FIG. 8, is launched.

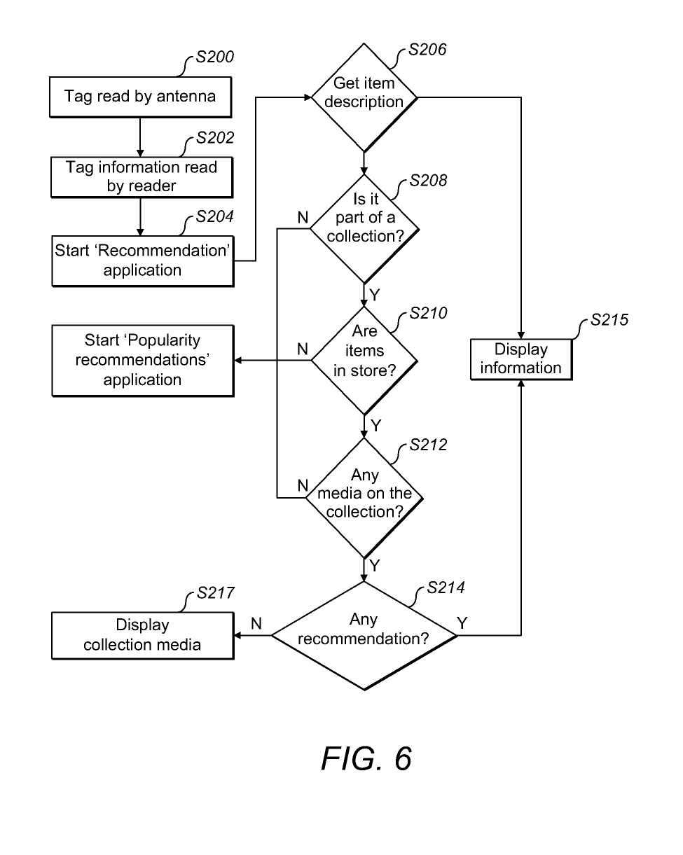

The following applies to the ‘branding’ software application and to the other software applications which will be described in relation to FIGS. 6 to 9. At any time when the display device 6 is active, i.e. displays information relating to a first clothing item on the basis of a first detected RFID tag (step S115), the presence of a further RFID tag is monitored by the RFID reader antenna 10, step S116. If a further tag is detected and the detected tag information is different to the first detected tag, as determined in step S118, such as in the case of a person holding a second clothing item in front of the display arrangement 2, it is preferable that the displayed information relating to the first clothing item is replaced automatically by information relating to the second item, step S106 again. Alternatively, a prompt may be displayed for the person to confirm whether he/she wants to switch to the second clothing item information to be displayed.

At any time when the display device 6 is active, step 115, a user input is sensed on the touch-sensitive mirror surface and if a user input is sensed a corresponding action is triggered. A corresponding action may be the transmission of a request to at least one remote handheld device 18 or the display of further information relating to the clothing item held in front of the display arrangement 2.

A history of clothing items held in front of the mirror for a predetermined time period may also be displayed with the possibility for a person to go back to previous clothing item information, either by holding that particular previous item in front of the mirror or by interacting with the touch-sensitive mirror surface. The display may be split up in different zones, each zone being used to display specific information; a first zone may for instance display information about a clothing item held in front of the display arrangement, a second zone displaying one or more suggested/recommended items, a third zone displaying one or more prompts for the person to interact with, etc. The zones may be of the same size and/or may be dynamically zoomed in/out in response to a person input on the touch-sensitive front surface of the mirror 4.

### ‘Recommendations’ Software Application

FIG. 6 illustrates the operation of the ‘recommendations’ software application which advises customers on one or more other clothing items based on the clothing item that the customer has brought in front of the display arrangement 2 of the present invention. The operation of this software application is as follows.

Presuming a person has approached the display arrangement 2 holding or wearing a clothing item having a tag attached, the item identification data has been read from the tag and that information about the item (e.g. price, size, color, material, etc) is displayed on the display device, step S215, it is first determined whether the clothing item is part of a collection, step S208. If the clothing item is part of a collection of clothing items, it is determined if the clothing items of the collection are in store, step S210. This step is carried out by querying the item database 16 for inventory information. If the clothing items are in store, it is determined if there is any media content about the collection, step S212. If the clothing item is not part of a collection or if the clothing items of the collection are not available (e.g. not in stock or on the shelves) or if there is no media content for the collection available, the ‘popularity recommendations’ software application, which will be described below in relation to FIG. 6, is launched. If there is media content about the collection, it is then determined if there are any recommendations in this collection, step S214, and if yes, the media content of the clothing item(s) recommended is displayed, step 215. If there is no recommendation, the collection media content is displayed instead, step 217.

### ‘Popularity Recommendations’ Software Application

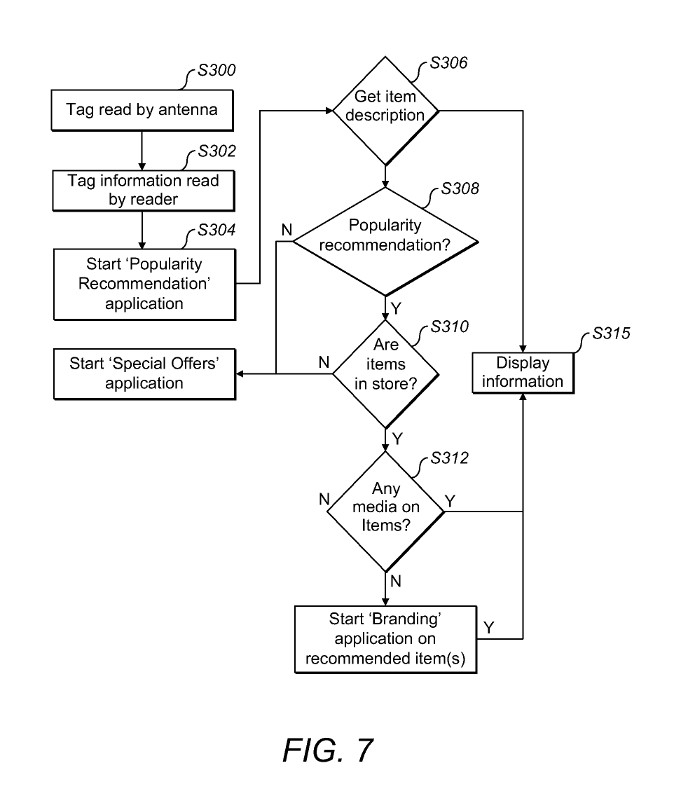

FIG. 7 illustrates the operation of the ‘popularity recommendations’ software application which advises customers on one or more other items based on the item that the customer has brought in front of the display arrangement 2 of the present invention. The operation of this software application is as follows.

Presuming a person has approached the display arrangement holding or wearing a clothing item having a tag attached, that item identifying data has been read from the tag and that information about the clothing item (e.g. price, size, color, material, etc) is displayed on the display device, step S315, it is first determined whether there are any popularity recommendations regarding other clothing items, step 308. If yes, it is determined if the one or more recommended clothing items are in store, step 310. If yes, it is further determined if there is any media content relating to the one or more recommended items, step 312. If yes, the media content relating to the one or more recommended items is displayed, step S315. If there is no media content relating to the one or more recommended items, step 312, the ‘branding’ software application, described in relation to FIG. 5, on the one or more recommended items is launched. In the case that there are no popularity recommendations in step S308 or the one or more recommended items are not available, step S310, the ‘special offers’ software application, which will be described in relation to FIG. 8, is launched.

‘Special offers’ Software Application

FIG. 8 illustrates the operation of the ‘special offers’ software application which advises customers on one or more other items based on the item that the customer has brought in front of the display arrangement 2 of the present invention. The operation of this software application is as follows.

Presuming a person has approached the display arrangement holding or wearing a clothing item having a tag attached, that item identification data has been read from the tag and that information about the clothing item (e.g. price, size, color, material, etc) is displayed on the display device, step S415, it is first determined whether there are any special offers, step S408. If there are special offers, it is determined if the clothing items covered by the special offers are in store, step S410. If there are in store, an indication of the availability of these clothing items is displayed, step S415, possibly with an indication of where exactly in the store these clothing items are located.

If there are no special offers (step S408) or if the clothing items covered by the special offers are not available in store (step S410), it is determined if there is any brand media content available, in step S414. If yes, such brand media content is displayed, in step S415. If not, it is determined if there any advertising material available, step S416, which may be displayed in step S415 according to availability.

### ‘Fitting Room’ Software Application

FIG. 9 illustrates the operation of the ‘fitting room’ software application which allows customers, when in a fitting room, to request help and specify a larger or a smaller clothing item based on what they are trying on in front of the display arrangement 2 of the present invention. The operation of this software application is as follows.

Presuming a person has approached the display arrangement holding or wearing a clothing item having a tag attached, that item identification data has been read from the tag and that information about the item (e.g. price, size, color, material, etc) is displayed on the display device, step S515, it is first determined whether the same clothing item exists in larger or smaller sizes and/or different colors (step S508), and if these are available in store (step S510). Information on the availability of the same clothing item in different sizes and/or colors is displayed, step S515. Available alternative items are preferably associated with one or more prompts which the customer may interact with via the touch-sensitive surface of the mirror. If it is sensed that a help prompt, a larger/smaller size prompt or a different color prompt has been selected by the customer by touching the mirror front surface, step S512, the request is sent to at least one handheld device 18 so that a salesperson can bring the required item or come to assist the customer. If there is some advertising material available (step S514), this is displayed, step S515, while the customer is waiting for the salesperson for instance. If there is no advertising material available, the ‘branding’ software application described previously is launched.

### Handheld Device 18

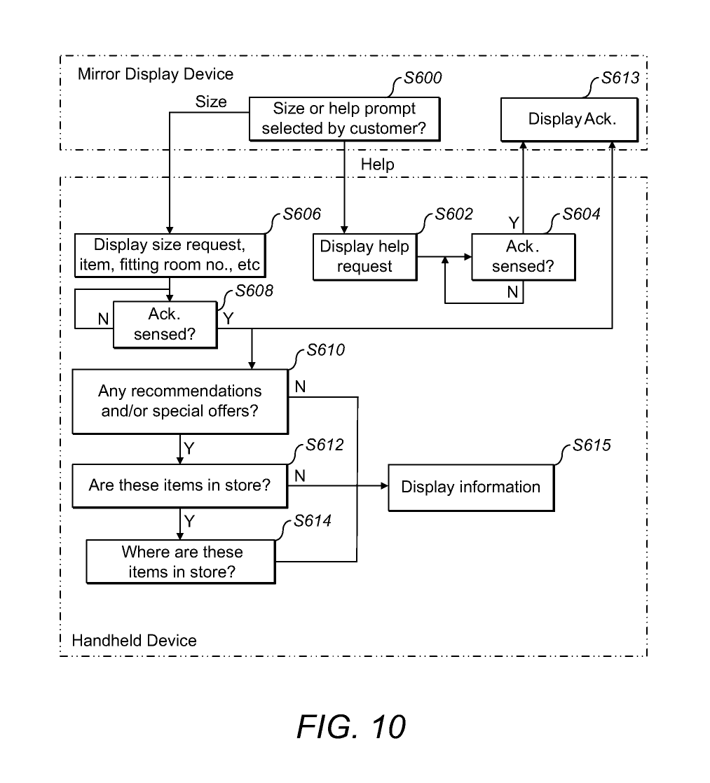

FIG. 10 illustrates the operation of a handheld device in combination with the display arrangement in accordance with an embodiment of the present invention.

Presuming that a help prompt and/or one or more larger/smaller size prompts are displayed on the display device 6 of the display arrangement 2, it is determined if a prompt has been selected by the customer, step S600. If a help prompt is activated, the help request is transmitted to a handheld device 18 and a corresponding help request is displayed on the screen of the device (S602) so that a salesperson can be warned that the customer requires assistance. The salesperson may acknowledge the request via the handheld device 18, step S604, the acknowledgement being transmitted to the display arrangement 2 so that a message of the type “A salesperson is on their way to assist you” can be displayed on the display device 6, step S613.

If a larger/smaller size prompt has been selected, the request is transmitted to the handheld device 18 and information such as the requested size, the item details, where in the store the item is located, the fitting room number in which the customer is located, is displayed on the screen of the handheld device 18 (step S606). The salesperson may acknowledge the request via the handheld device 18, step S608, the acknowledgement being transmitted to the display arrangement 2 so that a message of the type “A salesperson is on their way with the requested item” can be displayed on the display device 6, step S613. Based on the clothing item requested by the customer, it is determined if there are any recommendations (e.g. popularity recommendations) and/or special offers (step S610) whose details may be transmitted to the handheld device 18 for the salesperson to bring some extra clothing items to the customer, provided that they are available in store (steps S612 and S614).

Various requests may be displayed on the handheld device 18 in response to a prompt being selected by a customer on the mirror front surface, including requests of the type “I want help on a clothing item I have with me”, “I would like you to bring me a recommended clothing item”, “I want a larger or smaller size”, “I want more information on something I have just seen in the mirror”.

In addition, the display arrangement of the present invention may provide the retailer with compiled data indicating which clothing items have been brought in front of the display arrangement for a specified period of time, e.g. on a daily basis. This could prove useful to a retailer in identifying trends or the impact of an offer for instance.

Yet further, the display arrangement of the present invention may provide fitting room loss prevention functionality. This may be provided with various different levels that any retailer can change according to their business rules. The software application may include features such as item count, value amount, and probable theft combinations. The detection of a potential level of risk of loss may result in various loss prevention actions being automatically triggered, such as a fitting room camera recording function being triggered and/or an alert being sent to the handheld device 18. The alerts being sent to the handheld device 18 can have different priorities, and may be sent to different handheld devices 18. For example, one level of alert may be sent to a handheld device 18 of a sales associate instructing the sales associate to engage the customer, a next level of alert may be sent to a handheld device 18 of a floor manager instructing the floor manager to engage the customer, and an even higher level of alert may be sent to a handheld device 18 of a security manager instructing the security manager to engage the customer.

For example, if a customer enters a fitting room with a number of items, the display arrangement 2 may display images of all items, a description of each item, individual and total value amounts and a “welcome” text.

If the number of items, the value of the items and the item combinations are acceptable according to the rules, the customer may try the items on in the fitting room, and interact with sales staff via the display arrangement as described above.

However, if the item count is above an acceptable item count threshold, or if the item combination value is above an acceptable item combination value threshold, or if the item combination has attributes which are otherwise flagged as high loss risk combination (e.g. two items in the same style, color, and/or size), this will trigger at least one of the various loss prevention actions described above.

The above embodiments are to be understood as illustrative examples of the invention. Further embodiments of the invention are envisaged. For example, the mirror may not be partly-transmissive throughout, and may for example be partly-transmissive only in a relatively small area corresponding to the display area. Also, the display device may not be located inside the enclosure of the display arrangement but may instead be located on one side of the enclosure.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A display arrangement having a user-facing side which, in use, faces a user, the display arrangement comprising:
a display device; and
a data reader device for reading data from a data carrier associated with an item, said data including item identification data,
wherein said display arrangement has a database interface for accessing a database, said database storing content data in correspondence with item identification data for a plurality of items,
said display device being responsive to item identification data being read by said data reader device from a data carrier to display content data on said user-facing side,
wherein said user-facing side includes a mirror, and
wherein a user sees both a reflection from said mirror and said displayed image when the user is in front of said user-facing side.

2. A display arrangement according to claim 1, said mirror comprising a partly-transmissive mirror.

3. A display arrangement according to claim 2, said mirror having a rear side and said display device being arranged to display an image towards said rear side, the image being visible through said partly-transmissive mirror.

4. A display arrangement according to claim 1, said data reader device comprising a radio frequency data reader device.

5. A display arrangement according to claim 1, comprising a plurality of items, wherein a different said data carrier is attached to each of said plurality of items.

6. A display arrangement according to claim 5, said data carriers each comprising an RFID tag.

7. A display arrangement according to claim 5, said items being clothing items.

8. A display arrangement according to claim 7, said mirror having a height of at least 150 cm.

9. A display arrangement according to claim 1, said mirror being touch-sensitive, wherein when said display device displays an image which is visible on said user-facing side of said display arrangement, said display device is responsive to a user input on said touch-sensitive mirror.

10. A display arrangement according to claim 1, said display arrangement being coupled to at least one wireless handheld device, said display arrangement being responsive to item identification data being read by said data reader device from a data carrier to transmit data to said at least one wireless handheld device.

11. A display arrangement according to claim 10, said display arrangement being responsive to a user input, in addition to data read by said data reader device from a data carrier, to transmit data to said wireless handheld device.

12. A display arrangement having a user-facing side which, in use, faces a user, the display arrangement comprising:
a plurality of data carriers;
a plurality of items, wherein a different said data carrier is attached to each of said plurality of items;
a display device; and
a data reader device for reading data from a data carrier attached to an item, said data including item identification data,
wherein said display arrangement has a database interface for accessing a database, said database storing content data in correspondence with item identification data for a plurality of items,
said display device being responsive to item identification data being read by said data reader device from a data carrier to display content data on said user-facing side,
wherein said user-facing side includes a mirror, said mirror comprising a partly-transmissive mirror, said mirror having a rear side and said display device being arranged to display an image towards said rear side, the image being visible through said partly-transmissive mirror, and
wherein a user sees both a reflection from said mirror and said displayed image when the user is in front of said user-facing side.

13. A display arrangement according to claim 12, said data carriers each comprising an RFID tag.

14. A display arrangement according to claim 12, said items being clothing items.

15. A display arrangement according to claim 14, said mirror having a height of at least 150 cm.
